(19) United States
(12) Patent Application Publication
(10) Pub. No.: US 2020/0168861 A1
(43) Pub. Date: May 28, 2020

(54) HOUSING ASSEMBLY FOR USE WITH ENERGY STORAGE SYSTEMS

(71) Applicant: Green Light Innovations, Lake Saint Louis, MO (US)

(72) Inventor: Timothy G. Fallon, Lake Saint Louis, MO (US)

(21) Appl. No.: 16/674,730

(22) Filed: Nov. 5, 2019

Related U.S. Application Data
(60) Provisional application No. 62/755,635, filed on Nov. 5, 2018.

(51) Int. Cl. H01M 2/10

(52) U.S. Cl. CPC H01M 2/105; H01M 2/1077

(57) ABSTRACT

A housing assembly for use with one or more batteries includes a first subassembly, a second subassembly, a plurality of sleeves, and a plurality of support members. A sleeve includes a sidewall defining a longitudinal channel sized to retain a plurality of cells therein. A sleeve coupling mechanism corresponding to an end coupling mechanism of the first subassembly is at a first wall end portion of the sidewall, and another sleeve coupling mechanism corresponding to an end coupling mechanism of the second subassembly is at a second wall end portion of the sidewall. A support member includes a member coupling mechanism corresponding to an end coupling mechanism of the first subassembly is at a first member end portion of the support member and another member coupling mechanism corresponding to an end coupling mechanism of the second subassembly is at a second member end portion of the support member.

### CROSS-REFERENCE TO RELATED APPLICATION

This application claims the benefit of U.S. Provisional Application No. 62/755,635, filed Nov. 5, 2018.

### BACKGROUND

With the proliferation of portable electronics and other electrical products, there is a rising demand for batteries and other portable energy storage systems used to power such electronics and other electrical products. A wide range of products (e.g., pacemakers, smoke detectors, computer motherboards, flashlights, smart phones, laptop computers, power tools, and electric vehicles) are powered using lithium or lithium-ion batteries, for example, due to their relatively high energy-to-weight ratio.

Even more, this rise in demand is poised to intensify as energy storage technology continues to improve and associated costs continue to decrease. In an attempt to keep up with demand, various energy storage systems are already being manufactured in large quantities and shipped around the world. At least some of these energy storage systems, however, are fraught with risk of short circuits, overheating, fire, explosion, chemical release, and/or other incident, especially when handled, packaged, and/or transported in any manner other than optimal. For example, some known energy storage systems are susceptible to vibration, impact, and/or heat. Moreover, some known solutions for storing and/or transporting energy storage systems are labor-intensive, time-consuming, and/or cost-prohibitive to perform or use in an optimal manner. For example, some known solutions involve disassembling a battery so that each cell may be handled and transported individually, and then reassembling the battery at the destination.

### SUMMARY

In one aspect, a housing assembly is provided for use with one or more batteries. The housing assembly includes a first subassembly, a second subassembly, a plurality of sleeves extending longitudinally between the first subassembly and the second subassembly, and a plurality of support members extending longitudinally between the first subassembly and the second subassembly. The first subassembly includes a first exterior surface, a first interior surface opposite the first exterior surface, and a first end coupling mechanism and a second end coupling mechanism at the first interior surface. The second subassembly includes a second exterior surface, a second interior surface opposite the second exterior surface, and a third end coupling mechanism and a fourth end coupling mechanism at the second interior surface. The third end coupling mechanism of the second subassembly is different from the first end coupling mechanism of the first subassembly. A first sleeve of the plurality of sleeves includes a sidewall defining a longitudinal channel sized to retain a plurality of cells therein, a first sleeve coupling mechanism corresponding to the first end coupling mechanism of the first subassembly at a first wall end portion of the sidewall, and a second sleeve coupling mechanism corresponding to the third end coupling mechanism of the second subassembly at a second wall end portion of the sidewall. A first support member of the plurality of support members includes a first member coupling mechanism corresponding to the second end coupling mechanism of the first subassembly at a first member end portion of the first support member and a second member coupling mechanism corresponding to the fourth end coupling mechanism of the second subassembly at a second member end portion of the first support member.

In another aspect, a method is provided for making a portable system for energy storage. The method includes coupling a plurality of sleeves to a first subassembly. A first sleeve, for example, includes a first sleeve coupling mechanism coupleable to a first end coupling mechanism of the first subassembly. The method further includes positioning a plurality of cells in a longitudinal channel defined by a sidewall of the first sleeve, and coupling a plurality of support members to the first subassembly. A first support member, for example, includes a first member coupling mechanism coupleable to a second end coupling mechanism of the first subassembly. The method further includes coupling a second subassembly to the sleeves and support members such that the sleeves and support members extend longitudinally between the first subassembly and the second subassembly. The second subassembly includes a third end coupling mechanism coupleable to a second sleeve coupling mechanism of the first sleeve and a fourth end coupling mechanism coupleable to a second member coupling mechanism of the first support member. The third end coupling mechanism of the second subassembly is different from the first end coupling mechanism of the first subassembly.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF THE DRAWINGS

Features, aspects, and advantages of the present disclosure will become better understood when the following Detailed Description is read with reference to the accompanying drawings in which like reference characters represent like elements throughout, wherein:

FIG. 1 is a schematic drawing of an example energy storage device.

FIG. 2 is a perspective view of an example housing assembly that may be used with energy storage systems, such as the energy storage device shown in FIG. 1.

FIG. 3 is an end view of the housing assembly.

FIG. 4 is an exploded view of the housing assembly.

FIG. 5 is a schematic sectioned side view of the housing assembly.

FIG. 6 is a schematic sectioned end view of the housing assembly.

FIG. 7 is a cross-sectional view of the housing assembly taken along the line A-A shown in FIG. 5.

FIG. 8 is a cross-sectional view of the housing assembly taken along the line D-D shown in FIG. 6.

FIG. 9 is a portion of the schematic sectioned side view of the housing assembly taken at circle B shown in FIG. 5.

FIG. 10 is a portion of the schematic sectioned side view of the housing assembly taken at circle C shown in FIG. 5.

FIG. 11 is a perspective view of an example container that may be used with a housing assembly, such as the housing assembly shown in FIG. 2.

FIG. 12 is another perspective view of the container shown in FIG. 11.

FIG. 13 is schematic end view of the container shown in FIG. 11.

FIG. 14 is a schematic side view of the container shown in FIG. 11.

Although specific features of various examples may be shown in some drawings and not in others, this is for convenience only. Any feature of any drawing may be referenced and/or claimed in combination with any feature of any other drawing.

### DETAILED DESCRIPTION

The present disclosure relates to structural assemblies and, more particularly, to a housing assembly for use with energy storage systems. The housing assembly may be used, for example, to handle and/or transport energy storage systems in a safe, efficient, and effective manner Examples described herein include a first subassembly, a second subassembly, a plurality of sleeves extending longitudinally between the first and second subassemblies, and a plurality of support members extending longitudinally between the first and second subassemblies. A first sleeve includes a sidewall defining a longitudinal channel sized to retain a plurality of energy storage systems (e.g., cells) therein and, at each end portion of the sidewall, a coupling mechanism for coupling the first sleeve to the first and second subassemblies. A first support member includes coupling mechanisms at each end portion for coupling the first support member to the first and second subassemblies.

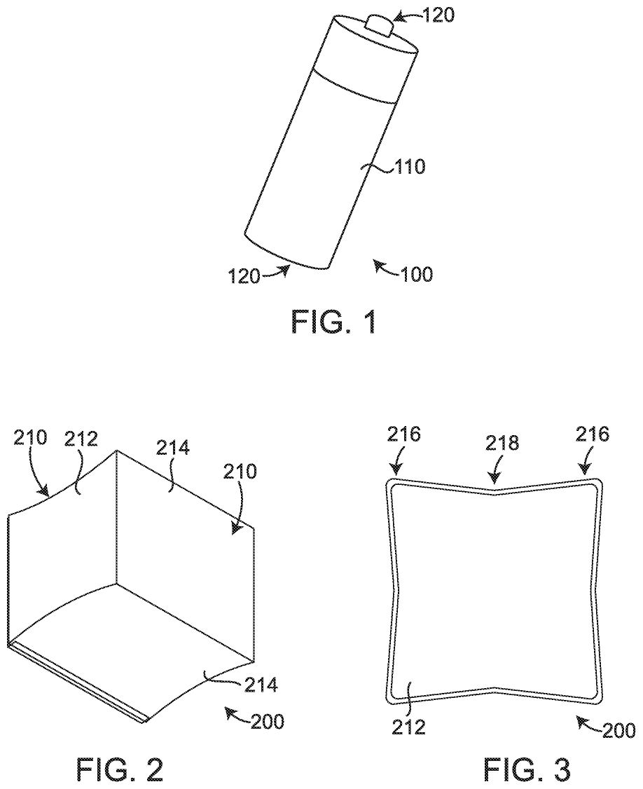

FIG. 1 shows an example battery 100 configured to store energy (e.g., in the form of chemical energy) and produce electricity by transforming the stored energy into an electron flow or electric current. The battery 100 includes a body 110 and a pair of terminals 120 that are spaced from each other. As shown at FIG. 1, the terminals 120 may be at opposite sides of the body 110. In some examples, chemical reactions in the battery 100 create a voltage or potential difference between the terminals 120. An oxidation-reduction or redox reaction, for example, may produce an accumulation of free electrons at one terminal 120 (e.g., at a negative terminal or anode) and/or an accumulation of ions at the other terminal 120 (e.g., at a positive terminal or cathode).

The terminals 120 serve as connection points for operatively connecting the battery 100 to one or more other components (e.g., for performing work). One or more conductors (not shown), for example, may be extended between the terminals 120 to close a circuit and allow electrons to flow therethrough toward the electron-starved cathode while ions flow within the battery 100 (e.g., through an electrolyte) in a complementary direction. This discharge state continues until the electrolyte is completely transformed and the ions stop moving through the electrolyte. In some examples, the battery 100 is configured to reverse the chemical reactions and transform electrical energy into stored energy (i.e., the battery 100 may be a rechargeable battery). When a charger (not shown) provides the battery 100 with electrical energy, ions flowing from the cathode may be intercalated or plated back onto the anode.

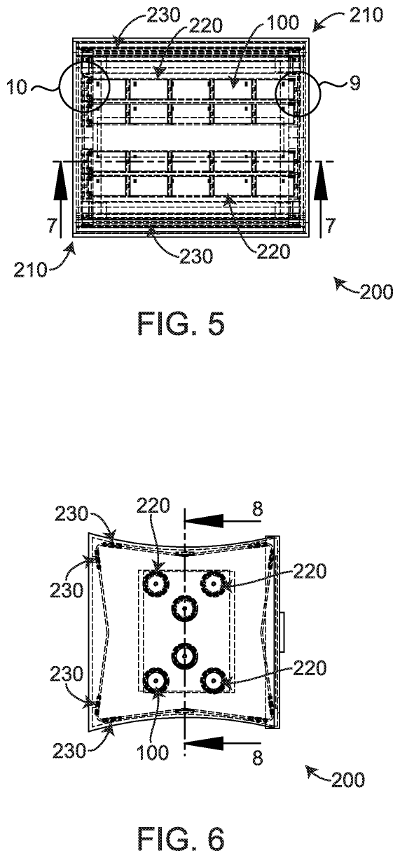

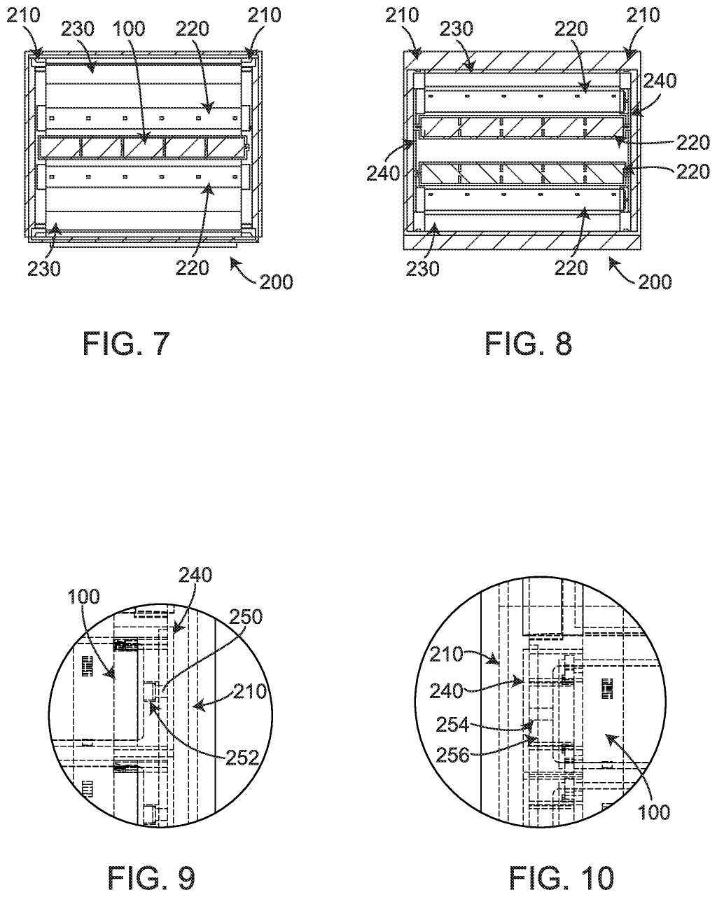

FIGS. 2-8 show an example housing assembly 200 that is configured to house one or more energy storage systems, such as a lithium or lithium-ion battery. The housing assembly 200 includes a plurality of panels 210 that are coupled together to define a cavity. In some examples, the panels 210 include a pair of end panels 212 and a plurality of side panels 214 extending between the end panels 212. An end panel 212 may have a pair of side portions 216 and a middle portion 218 extending between the side portions 216. As shown in FIG. 3, the middle portion 218 may span a distance that is shorter than a distance spanned by the side portions 216. In this manner, one or more end panels 212 and/or side panels 214 may have a contoured or concave configuration. Additionally or alternatively, one or more end panels 212 and/or side panels 214 may have a substantially planar and/or convex configuration.

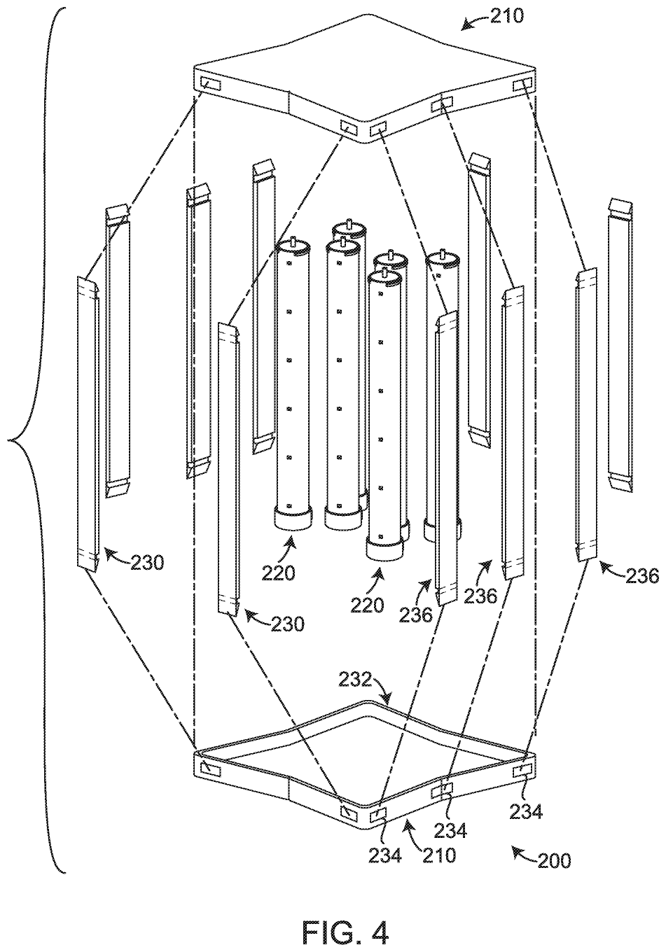

As shown in FIGS. 4-8, the housing assembly 200 may include a plurality of cylinders or containers 220 extending in the cavity between the end panels 212. Each container 220 is configured to house one or more cells (e.g., batteries 100) joined in series. One or more end caps may be coupled to the longitudinal ends of each container 220. As shown in FIG. 4, the end caps may include a nipple end cap and a flat end cap. Additionally, the housing assembly 200 may include a plurality of support members 230 extending in the cavity between the end panels 212. The containers 220 may be spaced from each other at an inner (e.g., toward the center) portion of the end panels 212, and the support members 230 may be spaced circumferentially about the containers 220 at a peripheral (e.g., toward the edges) portion of the end panels 212. In some examples, each end panel 212 includes a rim portion 232 having a plurality of depressions or undercut portions 234 (e.g., slits, notches, indentations) that are sized and configured to receive protruding portions 236 (e.g., lug, hook, bead) of the support members 230 (e.g., in a snap joint arrangement). It is contemplated that other coupling mechanisms may be used to couple the support members 230 to the end panels 212. The support members 230 provide structural support that enables the housing assembly 200 to maintain its shape and form.

As shown in FIG. 8, at an interior surface of one or more end panels 212, the housing assembly 200 may include one or more printed circuit boards (PCBs) 240. The printed circuit boards 240 may be configured to join the batteries 100 in series or in parallel. In some examples, the housing assembly 200 includes one or more biasing mechanisms 250 that couple the batteries 100 to a PCB 240 while spacing the batteries 100 from the PCB 240. In this manner, the biasing mechanisms 250 may manage or regulate a pressure or force applied to the PCB 240. As shown in FIG. 9, a biasing mechanism 250 may be directly connected to a nipple end 252 of a battery 100 on one end and to an interior surface of the PCB 240 on the opposite end. Additionally or alternatively, as shown in FIG. 10, the housing assembly 200 may include a nipple set 254 that is directly connected to a flat end 256 of a battery 100 on one end and to an interior surface of the PCB 240 on the opposite end.

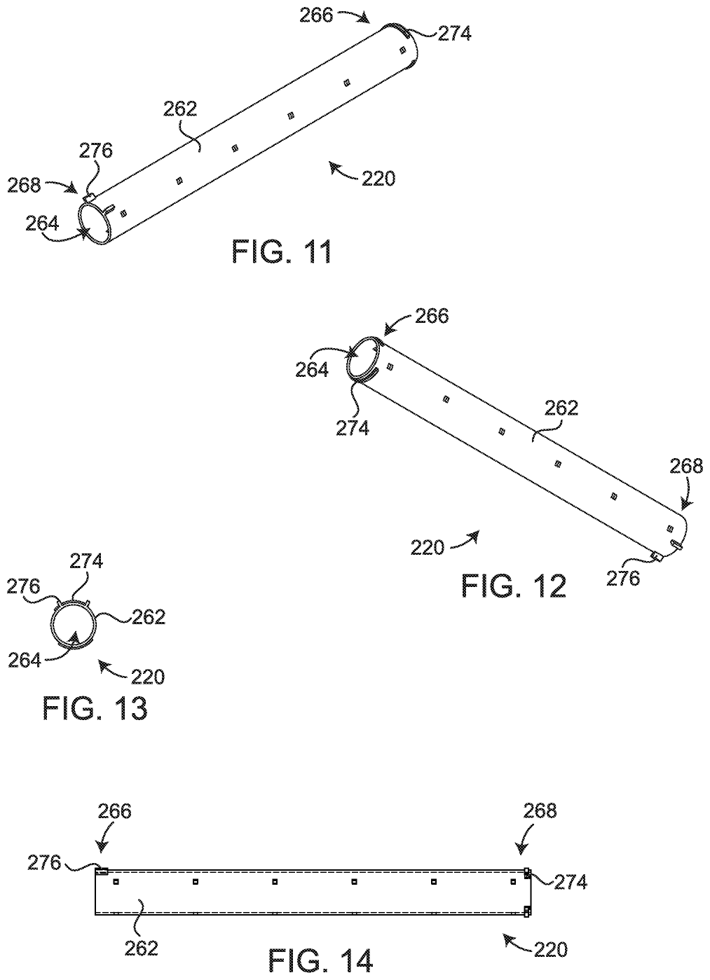

FIGS. 11-14 show a container 220 (e.g., a first housing) including a sidewall 262 defining a longitudinal channel 264 sized to retain one or more batteries 100 therein. For example, the sidewall 262 may have an inner diameter of approximately 3.24 centimeters (cm), an outer diameter of approximately 3.64 cm, and/or a length of approximately 34.59 cm between a first end portion 266 of the sidewall 262 and a second end portion 268 of the sidewall 262 opposite the first end portion 266.

The container 220 includes a first coupling mechanism 270 at the first end portion 266 of the sidewall 262, and a second coupling mechanism 272 different from the first coupling mechanism 270 at the second end portion 268 of the sidewall 262. As shown in FIGS. 11-14, the first coupling mechanism 270 may include one or more helical or circumferential members 274 extending radially outward from and generally circumferentially about the sidewall 262, and the second coupling mechanism 272 may include one or more longitudinal members 276 extending radially outward from and generally longitudinally along the sidewall 262. In some examples, the first coupling mechanism 270 and second coupling mechanism 272 are coupleable to a complementary coupling mechanism at the interior surfaces of the PCBs 240. For example, a first PCB 240 may have a first set of coupling mechanisms configured to cooperate with or engage the circumferential members 274, and a second PCB 240 may have a second set of coupling mechanism configured to cooperate with or engage the longitudinal members 276.

During assembly, a first connector plate (e.g., PCB 240) is coupled to a first end panel 212 to form a first subassembly, and a second connector plate (e.g., PCB 240) is coupled to a second end panel 212 to form a second subassembly. The first subassembly includes a first exterior surface, a first interior surface opposite the first exterior surface, and a first plurality of coupling mechanisms at the first interior surface. When coupled, the first connector plate is proximate and generally parallel with the first interior surface. The first plurality of coupling mechanisms may include, for example, one or more arcuate elements for coupling to one or more containers 220 (e.g., a first end coupling mechanism), and one or more undercut portions 234 for coupling to one or more support members 230 (e.g., a second end coupling mechanism). Each arcuate element is spaced from the first interior surface such that a circumferential member 274 of a container 220 is positionable therebetween.

The second subassembly includes a second exterior surface, a second interior surface opposite the second exterior surface (and facing the first interior surface), and a second plurality of coupling mechanisms at the second interior surface. When coupled, the second connector plate is proximate and generally parallel with the second interior surface. The second plurality of coupling mechanisms may include, for example, one or more standing elements for coupling to one or more containers 220 (e.g., a third end coupling mechanism), and one or more undercut portions 234 for coupling to one or more support members 230 (e.g., a fourth end coupling mechanism). The standing elements extend generally perpendicularly from the second interior surface. That is, the standing elements are different from the arcuate elements.

To securely couple the containers 220 to the first subassembly, each container 220 is positioned at the first interior surface of the first subassembly such that its circumferential member 274 is offset from a respective arcuate element (e.g., in an end-to-end arrangement) and then rotated such that its circumferential member 274 is generally aligned with its respective arcuate element (e.g., in an overlapping arrangement). The support members 230 are positioned circumferentially about the containers 220 at a peripheral portion of the first subassembly, and aligned with the undercut portions 234 of the first subassembly. The support members 230 are then moved toward the first subassembly such that the protruding portions 236 of the support members 230 cooperate with or engage the undercut portions 234.

The second subassembly is positioned such that the second interior surface faces the second end portions 268 (e.g., the longitudinal members 276 extend generally perpendicular to the second interior surface), and then moved toward the containers 220 such that the standing elements slide generally parallel with the longitudinal members 276. In this manner, the standing elements cooperate with or engage the longitudinal members 276 of a container 220 such that the second subassembly is secured relative to the container 220 in a horizontal direction. Additionally, the protruding portions 236 of the support members 230 cooperate with or engage the undercut portions 234 of the second subassembly such that the second subassembly is secured relative to the containers 220 in a vertical direction.

To disassemble the housing assembly 200, the second subassembly is decoupled from the support members 230 (and the containers 220) by disengaging the protruding portions 236 of the support members 230 from the undercut portions 234 of the second subassembly and moving the second subassembly vertically away from the rest of the housing assembly 200. To facilitate disassembly, the first exterior surface and/or second exterior surface may have a perceptible indicia that enables the first subassembly and the second subassembly to be distinguished from each other.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. Furthermore, references to an “embodiment” or “example” of the present disclosure are not intended to be interpreted as excluding the existence of additional embodiments or examples that also incorporate the recited features. The terms “comprising,” “including,” and “having” are intended to be inclusive and mean that there may be additional elements other than the listed elements. The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims As various changes could be made in the above constructions, products, and methods without departing from the scope of aspects of the disclosure, it is intended that all matter contained in the above description and shown in the accompanying drawings shall be interpreted as illustrative and not in a limiting sense.

While aspects of the disclosure have been described in terms of various examples with their associated operations, a person skilled in the art would appreciate that a combination of operations from any number of different examples is also within the scope of the aspects of the disclosure.

What is claimed is:

1. A housing assembly for use with one or more batteries, the housing assembly comprising:
a first subassembly including a first exterior surface, a first interior surface opposite the first exterior surface, a first end coupling mechanism at the first interior surface, and a second end coupling mechanism at the first interior surface;
a second subassembly including a second exterior surface, a second interior surface opposite the second exterior surface, a third end coupling mechanism at the second interior surface, and a fourth end coupling mechanism at the second interior surface, wherein the third end coupling mechanism of the second subassembly is different from the first end coupling mechanism of the first subassembly;
a plurality of sleeves extending longitudinally between the first subassembly and the second subassembly, wherein a first sleeve of the plurality of sleeves includes a sidewall defining a longitudinal channel sized to retain a plurality of cells therein, a first sleeve coupling mechanism corresponding to the first end coupling mechanism of the first subassembly at a first wall end portion of the sidewall, and a second sleeve coupling mechanism corresponding to the third end coupling mechanism of the second subassembly at a second wall end portion of the sidewall; and
a plurality of support members extending longitudinally between the first subassembly and the second subassembly, wherein a first support member of the plurality of support members includes a first member coupling mechanism corresponding to the second end coupling mechanism of the first subassembly at a first member end portion of the first support member, and a second member coupling mechanism corresponding to the fourth end coupling mechanism of the second subassembly at a second member end portion of the first support member.

2. The housing assembly of claim 1, further comprising a plurality of panels extending between the first subassembly and the second subassembly to define a cavity sized to retain the plurality of sleeves and the plurality of support members therein.

3. The housing assembly of claim 1, further comprising a first panel extending between the first subassembly and the second subassembly, wherein the first panel has a concave configuration.

4. The housing assembly of claim 1, wherein the first subassembly includes a first rim portion extending about the first interior surface of the first subassembly, and the second subassembly includes a second rim portion extending about the second interior surface of the second subassembly.

5. The housing assembly of claim 1, wherein the first subassembly and the second subassembly each include an edge having a concave configuration.

6. The housing assembly of claim 1, wherein the first end coupling mechanism of the first subassembly includes a arcuate element spaced from the first interior surface of the first subassembly, and the first sleeve coupling mechanism of the first sleeve includes a circumferential member that complements the arcuate element.

7. The housing assembly of claim 1, wherein the second end coupling mechanism of the first subassembly defines a slit extending therethrough, and the first member coupling mechanism of the first support member includes a lug configured to extend at least partially through the slit.

8. The housing assembly of claim 1, wherein the third end coupling mechanism of the second subassembly includes a standing element generally perpendicular to the second interior surface of the second subassembly, and the second sleeve coupling mechanism of the first sleeve includes a longitudinal member generally in line with the standing element when the second sleeve coupling mechanism and the third end coupling mechanism couple the first sleeve to the second subassembly.

9. The housing assembly of claim 1, wherein the fourth end coupling mechanism of the second subassembly defines a slit extending therethrough, and the second member coupling mechanism of the first support member includes a lug configured to extend at least partially through the slit.

10. The housing of assembly of claim 1, wherein the first subassembly includes a first inner portion and a first peripheral portion extending about the first inner portion, the second subassembly includes a second inner portion and a second peripheral portion extending about the second inner portion, the plurality of sleeves extend between the first inner portion and the second inner portion, and the plurality of support members extend between the first peripheral portion and the second peripheral portion.

11. The housing assembly of claim 1, further comprising a connector plate proximate and generally parallel with one of the first interior surface of the first subassembly or the second interior surface of the second subassembly.

12. The housing assembly of claim 1, further comprising:
a first connector plate proximate the first interior surface of the first subassembly; and
a second connector plate proximate the second interior surface of the second subassembly.

13. The housing assembly of claim 1, further comprising a nipple proximate one of the first interior surface of the first subassembly or the second interior surface of the second subassembly, wherein the nipple is generally in line with the first sleeve.

14. The housing assembly of claim 1, further comprising:
a first nipple proximate the first interior surface of the first subassembly; and
a second nipple proximate the second interior surface of the second subassembly, wherein the first nipple and the second nipple are both generally in line with the first sleeve.

15. The housing assembly of claim 1, further comprising a biasing mechanism proximate one of the first interior surface of the first subassembly or the second interior surface of the second subassembly, wherein the biasing mechanism is generally in line with the first sleeve.

16. The housing assembly of claim 1, further comprising:
a first biasing mechanism proximate the first interior surface of the first subassembly; and
a second biasing mechanism proximate the second interior surface of the second subassembly, wherein the first biasing mechanism and the second biasing mechanism are both generally in line with the first sleeve.

17. The housing assembly of claim 1, wherein one of the first exterior surface or the second exterior surface has a perceptible indicia that distinguishes one of the first subassembly or the second subassembly from the other of the first subassembly or the second subassembly.

18. A method of making a portable system for energy storage, the method comprising:
coupling a plurality of sleeves to a first subassembly, the plurality of sleeves including a first sleeve, wherein coupling the plurality of sleeves comprises coupling a first sleeve coupling mechanism of the first sleeve to a first end coupling mechanism of the first subassembly, the first sleeve including a sidewall that defines a longitudinal channel;
positioning a plurality of cells in the longitudinal channel of the first sleeve;
coupling a plurality of support members to the first subassembly, the plurality of support members including a first support member, wherein coupling the plurality of support members comprises coupling a first member coupling mechanism of the first support member to a second end coupling mechanism of the first subassembly; and
coupling a second subassembly to the plurality of sleeves and to the plurality of support members such that the plurality of sleeves and the plurality of support members extend longitudinally between the first subassembly and the second subassembly, wherein coupling the second subassembly comprises coupling a third end coupling mechanism of the second subassembly to a second sleeve coupling mechanism of the first sleeve, and coupling a fourth end coupling mechanism of the second subassembly to a second member coupling mechanism of the first support member, the third end coupling mechanism of the second subassembly different from the first end coupling mechanism of the first subassembly.

19. The method of claim 18, further comprising coupling a plurality of panels to the first subassembly such that the plurality of panels and the first subassembly at least partially define a cavity retaining the plurality of sleeves and the plurality of support members therein, wherein coupling the second subassembly further comprises coupling the second subassembly to the plurality of panels such that the plurality of panels extend longitudinally between the first subassembly and the second subassembly.

20. The method of claim 18, further comprising:
extending a first connector plate proximate and generally parallel with an interior surface of the first subassembly;
coupling a plurality of biasing mechanisms to the first connector plate, the plurality of biasing mechanisms including a first biasing mechanism, wherein coupling the plurality of biasing mechanisms comprises aligning the first biasing mechanism such that the first biasing mechanism is generally in line with the first sleeve; and
coupling a plurality of nipples to the plurality of biasing mechanisms, the plurality of nipples including a first nipple, wherein coupling the plurality of nipples comprises aligning the first nipple with the first biasing mechanism such that a first cell of the plurality of cells is connected to the first nipple.
